(19) United States
(12) Patent Application Publication
(10) Pub. No.: US 2023/0075433 A1
(43) Pub. Date: Mar. 9, 2023

(54) Blockchain Based Document and Data Sharing

(71) Applicant: Chainyard Supplier Management, Inc., Morrisville, NC (US)

(72) Inventors: Mohan Venkataraman, Morrisville, NC (US); Sai Nidamarty, Morrisville, NC (US); Shyam Charit Adivi, Morrisville, NC (US); Alex Rosen, Morrisville, NC (US); Gary Storr, Morrisville, NC (US); Stephen John Rogers, Durham, NC (US); Derek Lamar Harrison, Durham, NC (US); Vishnu Praneeth Tadepalli, Durham, NC (US); Daniel J. Schaefer, Durham, NC (US); Murali Sappa, Morrisville, NC (US)

(21) Appl. No.: 17/977,106

(22) Filed: Oct. 31, 2022

Related U.S. Application Data
(63) Continuation-in-part of application No. 16/161,996, filed on Oct. 16, 2018, now Pat. No. 11,488,271.

(51) Int. Cl. G06F 16/93; H04L 9/08; H04L 9/32; H04L 9/00

(52) U.S. Cl. CPC G06F 16/93; H04L 9/085; H04L 9/3263; H04L 9/50

(57) ABSTRACT

This document presents a system and method for presenting vetted and verified Supplier information to Buyers. The Know Your Suppler (TYS) Application collects previously vetted and verified Supplier information and commits the collected information, verification authorities, verification details, and transaction information to a shared distributed ledger implemented as a privately permissioned blockchain. Buyers who want to onboard a newly identified Supplier, or update Supplier information with more recently verified information records, may subscribe to the TYS Application and purchase available vetted and verified Supplier information to optimize the onhoarding or updating process for Suppliers from whom the Buyer wants to purchase goods or services.

### CROSS-REFERENCE TO RELATED APPLICATION

This application is a continuation-in-part of U.S. application Ser. No. 16/161,996, filed and entitled Oct. 16, 2018, and entitled “System and Method for Supplier Information Management”.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### BACKGROUND

Buyers and Suppliers have complex contractual relationships that are based upon the course of business transacted between the corporate entities. These contractual relationships are based upon shared information that has been provided to a Buyer from a Supplier during the process of onboarding a new Supplier for each Buyer. The information provided is typically in the form of questionnaires that have a series of questions that attempt to assure a Buyer that the Supplier is capable of executing on purchasing contracts in a timely and effective manner. The process of answering the questionnaires can include verification steps to ensure that the answers provided are accurate and trustworthy. The information requested may also require information to be provided from third party sources, other than verification entities, that have no direct connection with the Buyer and Supplier.

Sharing data and documents once placed upon a Blockchain or within a database accessed through a blockchain based access can be very secure, but may not be easily achieved. Maintaining the trusted environment enabled by a Blockchain requires specific steps to locate and access the desired information. Requests for data or documents are readily honored as long as these specific steps are followed, which may often be time-consuming or difficult to follow.

### BRIEF DESCRIPTION OF THE DRAWINGS

Certain illustrative embodiments illustrating organization and method of operation, together with objects and advantages may be best understood by reference to the detailed description that follows taken in conjunction with the accompanying drawings in which:

FIG. 1 is a view of the end-to-end system interactive process components for the TYS platform consistent with certain embodiments of the present invention.

FIG. 2 is a view of the end-to-end system integration architecture consistent with certain embodiments of the present invention.

FIG. 3 is a view of the application architecture overview and the logical components of the TYS platform consistent with certain embodiments of the present invention.

FIG. 4 is a view of personal interaction with the blockchain and secure document sharing functions consistent with certain embodiments of the present invention.

FIG. 5 is a view of the Digital Identification (DID) authentication protocol consistent with certain embodiments of the present invention.

FIG. 6 is a view of data and operation flow for the TYS platform outbound process consistent with certain embodiments of the present invention.

FIG. 7 is a view of data and operation flow for the TYS platform partner process consistent with certain embodiments of the present invention.

FIG. 8 is a view of data and operation flow for the TYS platform partner processing consistent with certain embodiments of the present invention.

FIG. 9 is a view of the inbound message processing for the TYS platform consistent with certain embodiments of the present invention.

FIG. 10 is a view of the complete TYS Application processing consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

As used herein, the term “TYS” refers to the Trust Your Supplier system, which is a cross-industry blockchain based business network, deployed as a SaaS solution, to simplify and accelerate the onboarding and lifecycle management process of suppliers and provide them with digital identity and credentials.

As used herein, the term “blockchain” refers to a shared ledger system that may be privately or publicly provisioned, such as, in a non-limiting example, Hyperledger created by International Business Machines (IBM).

As used herein, the term “Node” refers to a copy of the ledger operated by a participant of the blockchain network.

As used herein, the term “Message Queue” refers to the message queues that allow different parts of a system to communicate and process operations asynchronously.

As used herein, the term “Microservices” refers to architectural patterns where various loosely coupled services work together to form an application. Each of these microservices focus on one single purpose only, encapsulating all related logic and data. Communications between services are conducted over well-defined Application Programming Interfaces (APIs).

As used herein, the term “Oracles” refers to those programming constructs that work as a bridge between the real world and the blockchain by providing data to the smart contracts.

As used herein, the term “workflow” is defined as the sequence of steps to be performed in order to execute each governance process including touchpoints with various systems and tools.

As used herein, the term “Change and release management” is defined as the process by which changes to the process, methods, tools, and the various components of the blockchain are recommended, processed and adopted. Changes can apply to network configurations, smart contracts, access control, feature enhancements, voting rights, phased availability of new features, bug fixes, enhancements to the platform based on defined schedules, as well as managing changes to other portions of the system as implemented.

As used herein, “audit and controls” defines all of the tools and know-how required to establish audit and controls, logging and reporting on audit points, interfaces to audit manually or through automatic means, and triggers to audit on-demand or periodically.

In an embodiment, a key use of a blockchain or blockchain enabled environment is to enable the sharing of documents and data in a trusted environment. In any supplier information system the ability to share such information in a trusted environment may be based upon the generation of secrets against share-keys which are distributed to the stakeholders, where the stakeholders are those parties that have a vested interest either in the generation or use of the information. The system herein described proposes the use of share policies and secrets lifecycle management on the blockchain. This system may leverage the “Shamir Algorithm” to generate the secrets associated with share keys. The Shamir Algorithm utilizes a secret that is split into shares for which a share key is generated for each share that composes the secret. In the Shamir Algorithm solution, the secret cannot be regenerated, and the data or information unlocked, unless a minimum subset of the shares is combined to reconstitute the secret. The Shamir Algorithm is utilized for those situations in which confidential or secret documents or data may be shared in a non-trusted environment without comprising the secrecy of the documents or data.

### System Elements:

The Supplier Information Management (SIM) system is implemented between multiple parties, typically organizations, that are engaged in one or more commercial transactions. A typical implementation will connect a TYS network to one or more outside business partner organizations. In an embodiment the parties may be individuals or organizations that are attempting to purchase goods and/or services, buyers, and individuals or organizations that may be desirous of selling goods and/or services to the buyer, known as sellers. The SIM system is structured to optimize and facilitate transactions between any buyer and a seller both from the standpoint of vetting and verifying information about each party to the other party, and from the standpoint of maintaining data security and guarding against fraud and fraudulent transactions.

An aspect assisting in one or more commercial transactions is the secrecy of the documentation or data that must be passed from a buyer to a seller in a non-trusted environment. The system herein described permits the sharing of documents and data whose location is URL defined and the sharing of data and documents stored on a blockchain ledger.

Blockchain Oracle:

An “Oracle” is a specific concept in the context of Blockchains and translates to components that provide a decentralized way for data from the outside world to be provided to smart contracts. A means for smart contracts to access data from the world outside the blockchain. A type of smart contract, oracles take data from the outside world and put the data into the blockchain for other smart contracts to consume.

Oracles must have certain guarantees on the data that an oracle makes available. One guarantee could take the form of cryptographic attestations. Oracles have to ensure that data has not been modified or tampered with when being moved from origin to destination and the origin sources of the data are trustworthy.

In a non-limiting example, a TYS Oracle Specification for data security may consist of a header, security parameters (entity that signs off on the data, a timestamp, origin information, destination information, source IP(s), aggregation information, Signature(s), secret or key information), Event Information (Message ID, Message type), and the Encrypted payload.

The TYS smart contract is a chaincode, also known as a smart contract, that runs inside the TYS blockchain environment. The main purpose of the TYS blockchain environment is to emit events received from TYS smart contracts to the TYS event listener and record the emitted events as requests in the ledger for future audit and compliance purposes. A smart contract may also record lifecycle messages about the event, such as the request for access to a secure document, received from the integration services such as when the event was sent and when the response was received.

An Oracle is the trusted integration component that ensures that outbound data to the TYS environment is signed to ensure that data was not tampered with or modified between the origin and destination of the data. The Oracle must ensure that the data being sent to TYS is originating from trusted sources of partner applications ad being transmitted without any tampering. This process differs from traditional integration or messaging services as each message that is inbound is signed by authorized credentials issued to the partner by the TYS system. In a non-limiting example, it is recommended that the Oracle be developed, deployed, and managed by a third party in their own environment, or on the TYS supported environment.

TYS Message Streams:

The message stream is a component comprised of partner inbound and outbound topics. In a non-limiting example, this component may be implemented using Kafka Event Streams. The TYS Integration Agent may deposit partner specific messages on the respective queues. The messages are detected and pushed to the partner agent by an API Gateway, which is a component of the system environment.

TYS Integration Agent:

The TYS Integration Agent listens to events broadcast by the TYS platform. The broadcast events may be marked attributes to provide meta-data about the events. The events may be queued by topics. There may be two types of messages, such as events that require consumption and processing by an external third party, and acknowledgements that show success or failure about the full round trip of an event processing.

TYS Partner Registry:

The TYS partner registry of integration endpoints to support a service that maps TYS events with third party endpoints and vice versa. All partner integrations have to be registered. The key attributes of each API in the registry may consist of a Message type, inbound and outbound data, inbound schema, outbound schema, schema format type, target organization name, and the target API end point.

TYS API Gateway:

The API gateway serves as the public interface to the partner agent. The gateway supports two types of interfaces. The first interface will look for partner specific messages and call the appropriate partner agent to hand off the partner specific messages. The second interface may wait for a partner to connect back and hand-off a response which the gateway drops in the appropriate response queue.

TYS Response Processing Services:

The TYS response processing services are microservices that are context sensitive to message types. Each service looks for responses in inbound topics for messages sent to partners. The services may pick up the response and processes them accordingly by calling the appropriate TYS NodeJS functions.

Data Transformation Service:

The transformation service transforms a message for consumption by the recipients of the message. The service will consume a transformation map that provides a mapping of TYS to the partner format and vice versa. In a non-limiting example, any service originating from the partner should be responsible for transforming and sending the data in TYS consumable format. In an alternative embodiment, there may be instances where the data transformation service may be performed by TYS. Transformation to the appropriate TYS format is currently the responsibility of a partner agent. The TYS platform may utilize a JSON-LD context file to share common vocabulary that can simplify transformation.

Message Exchange Format:

In an embodiment, TYS specific data attributes are mapped with partner data attributes. This mapping must be completed during an initialization phase so that the transformation engine within the TYS platform will know the data mapping. If the partner needs to send additional data at a later stage, the document needs to be updated and resent to that transformation engine is able to update the TYS to partner data mapping.

In a non-limiting example the key attributes of each map may consist of a header, in a non-limiting example, containing the fields of AppId, Correlation Id, MessageId, CreatedTS, Message_Type, Originator, Type, Destination, Hash, HashAlgorithm, Publickey, Signature, SignatureAlgorithm, SubscriberId, SubscriptionToken, ResponseStatus, ResponseErrorMessage, SubjectOrgId, and RequesterOrgId. Following the header the message payload is concatenated to the header.

Core Document Share Process Using Blockchain:

In an embodiment, the core pattern for secure document sharing utilizing a blockchain may include the elements of a share file dropbox, a KeyStore, a KeyGenerator, and a Share Client. In a non-limiting example, the participants in a document sharing operation will each have public/private keys issued to each participant. The public keys will be registered with the KeyStore, which stores the wallets for each participant, with a wallet registered to each participant and which contains only the public keys for that registered participant.

When a participant issues a request for the secure sharing of a document from another participant, the TYS platform initializes the action and stores both the request to share a document and the participant's authorization to make the request within the TYS managed chaincode. The participant's authorization is verified through a TYS platform authentication and policy verification process. If the participant is not authorized, or if the policies under which a request are not followed, the participant will not be permitted to make a secure document share request and the transaction will not be committed to the TYS platform blockchain.

When a properly authorized and recorded secure document share request is performed, the Share Client will notify the second participant(s) of the action and requests the secret from the second participant(s). The second participant(s) presents the participant(s) secret to the Share Client. Upon receipt of the secret(s), the Share Client verifies the secret(s) and transmits an access link to the second participant(s) to identify the requested secure document. The TYS platform is active to record the access to the link by the second participant(s) on the TYS blockchain. In this non-limiting example, the document may be removed from the URL location after the expiry of the secret that permitted the access.

The requesting participant receives an encrypted document from the second participant(s) and decrypts the document with the requesting participant's private key. The requesting participant re-encrypts the decrypted document with the shared public key from the requesting participant's Key Store wallet and send the re-encrypted document to the Share Client. The TYS blockchain is updated with the share events and the file access policy that is relevant to the shared document.

The TYS Share Client may then generate new sharing keys and secrets for both the requesting participant and each second participant and provides the share public key to the requesting participant. The newly generated Share Keys are stored in the Key Store for each participant. In this embodiment each secret is generated using the Shamir Algorithm which are stored in the wallets for each participant.

In an embodiment, the secure document sharing process may be guided by policies that have been put in place by one or more participants. The secure document sharing platform comprises the common elements of a share file dropbox, a KeyStore, a KeyGenerator, and a Share Client to facilitate the process of secure sharing. However, in this embodiment, instead of a direct sharing request from one participant the participant may create policies under which that participant will be willing to share documents and how this sharing will take place.

A participant may create one or more policies on sharing, which are conditions that must be met in order to enable and begin the sharing process. These policies are created by a participant and stored within the Share Client manager under the identifier of the participant who has created the policies. The Share Client manages all share requests. The one or more policies are created as smart contracts on the blockchain, with the conditions to be met as the items that must be fulfilled to meet the smart contract fulfillment requirements. Once the conditions of the policies are met and the contract is completed, the smart contract will inform the Share Client manager that the document sharing policies have been met and the Share Client may then initiate document shares automatically.

Similar to a direct document sharing request, a second participant may transmit a secure document sharing request. Once again, both the request from the second participant and the first participant's authorization for sharing are recorded on the TYS blockchain, after proper authentication and policy verification. The secure document sharing policies may be established by an individual participant, or may be input as an organizational requirement on behalf of all participants who are part of an organization. Policies establish the requirements that must be met within a smart contract to permit the secure document sharing. In a non-limiting example, a policy may establish a smart contract with the condition that multiple secrets from multiple participants must be transmitted and verified to fulfill the smart contract and initiate the secure document share. In a non-limiting example, a requirement may be set that for a document that has three participants, or owners, at least two of the three secrets held by the owners must be provided to meet the smart contract conditions and unlock the ability to share the document requested. In this example the Share Client will require the receipt of the secrets from at least two of the owners, but the set of share secrets will all point to the same instance of the shared document under management of the Share Client.

In an embodiment, the Know Your Supplier (KYS) system utilizes the secure document sharing capability described in this document to share documents and other data from the TYS blockchain in a secure fashion. The Key Store leverages wallets to store share keys and permit the access of the Share Client to the secrets contained within the Key Store and identified by participant or organization. In a non-limiting example, the Share Keys may be constructed based upon an elliptic curve digital signature algorithm (ECDSA). Shares may have associated policies and a life-cycle, and may be revoked. Shared documents may have multiple owners, in which case an algorithm for determining the number of owners required to provide access to a shared document will be created and used by the Share Client to authorize access to a shared document. Shared instances of documents are water-marked to prevent mis-use. This water-mark is an impurity added to a shared document to insure that a shared copy of the document cannot be mistaken for the original. All shared documents are downloaded as an impurity added copy of the original.

In an embodiment, a service of a double-blind supplier vetting through the integral Trust Your Supplier (TYS) Application is provided in the TYS platform as an implementation for the purchase and dissemination for secure shared documents in the TYS platform. The transaction occurs between two of more parties, such as a supplier and a Buyer. In this embodiment, a supplier may have provided the answers to a supplier questionnaire to a Buyer 1. Buyer 1 vetted and certified all of the information provided in the questionnaire prior to purchasing goods and services from the supplier. Buyer 1, as a member of the TYS network, may provide the vetted and certified information from the supplier to the TYS Application in a template form that is retained on a distributed ledger system, such as a blockchain. A Buyer 2 may wish to purchase goods and services from the same supplier and contacts the TYS Application to request and acquire vetted and certified information about the supplier rather than going through the entire process of vetting and certifying all of the supplier information directly from the supplier and certifiers. Buyer 1 may share the vetted and certified supplier information and documents stored and managed by the TYS Application with Buyer 2 through the TYS blockchain or chaincode Application. Buyer 1 and Buyer 2 are not known to one another. The TYS Application permits Buyer 2 to complete the secure purchase of the vetted and certified supplier information acquired by Buyer 1 and deposited with the TYS Application. Buyer 2 purchases the supplier information and Buyer 1 receives a credit with the SIM system to be redeemed later. The TYS system is active to push identity information from a Supplier to a Buyer as well if such a request is authorized.

In this embodiment, the transaction is double blind, but each party receives a benefit from the transaction. Buyer 2 optimizes the time and cost required to onboard the supplier, and Buyer 1 receives a credit with the TYS Application that may be used for their benefit in future transactions. The TYS Application, for managing the vetted and certified data in the TYS repository and TYS shared blockchain, and facilitating the transaction receives a transaction fee from both Buyer 1 and Buyer 2. In this fashion, the TYS Application provides oversight and management of Supplier certification, committing immutable transactions to the shared TYS blockchain and Off-chain data stores as needed to provide for data security, secure transaction provenance, and vetted and verified Supplier information.

In an embodiment, the SIM system platform provides for additional communication and operational capabilities. The platform contains an Artificial Intelligence (AI) engine to provide for actions that may be aided through the use of the AI engine. In a non-limiting example, upon change in a supplier's information that is presented to the system, the AI engine may utilize cognitive capabilities to automatically classify risk level and then notify buyers connected to that supplier based on their notification thresholds. The AI engine may also provide the capability to actively notify Suppliers when they need to update the Supplier information that is held in the system repository and on the blockchain. The AI engine may look for supplier's information on the web and from selective information sources and media. Upon discovering differences, the AI engine will alert the affected suppliers on changes to be made to their profile as it finds profile changes from the profile maintained on the blockchain. This notification may be transmitted as a push notification to each Supplier informing them to update information through an Intelligent API. As a portion of the tracking of Supplier information within the SIM system, a clear trail of the Supplier provenance for all changes to their profiles and committed Supplier information is maintained by the SIM system. As an additional capability, the AI engine may be active to match Buyers and Suppliers for targeted advertising recommendations. The AI engine may also provide an analysis of all Supplier provided information against Buyer expressed needs to source which Suppliers might be a good match for Buyers and provide an indication to Buyer members of the possible match. The AI engine could then provide the Supplier identification to the Buyer members should they indicate an interest and the Buyer member could then proceed to the Supplier onboarding process.

In an embodiment, the SIM system may also provide privileged access tracking and reporting capabilities. Each Supplier that is a member of the network managed and maintained by the SIM system controls their own digital identity and owns their own information. Each Supplier may transmit verified data and verification results to the SIM system and/or permit the transmission of verified information directly from verification providers. In each situation, the verified information will be placed on the blockchain and in the appropriate data store and associated clearly with the Supplier. The tracking and reporting capabilities of the SIM system also provide for billing users and paying sources of privileged information.

In an embodiment, data synchronization is tracked and managed within the TYS platform. Supplier profiles within the TYS environment may change over time due to various reasons, such as basic data, financials, reputation, ratings, or other parameters that may be contained within a supplier profile. In a non-limiting example, these changes may take the form of a change in corporate or billing addresses for a supplier. This information may need to be disseminated to one or more buyers and this data synchronization and update is performed by the TYS platform.

The TYS platform may facilitate this process by sending a notification to all impacted buyers on the platform indicating there are updates to the supplier information available. The buyers may then log in to the TYS platform and view these changes based on their roles and access privileges. These changes may then be imported to their systems by cutting and pasting the information to which they have access from the TYS platform to their own systems. Additionally, the integration service may notify partner systems and the partner systems may then retrieve the changes using the integration APIs and services on the TYS platform.

Data synchronization on the TYS platform may be implemented using the broadcast messaging pattern using the same publish-and-subscribe approach. The TYS platform may drop a message into a dedicated topic and all authorized subscribers may pull in the information from the dedicated topic repository. Alternatively, the TYS platform may drop a message in each topic repository that is associated with a particular subscriber or subscribers. The targeted subscribers will then be able to pull in the information from the topic repository to which they subscribe.

The TYS platform has a robust integration security capability. In the TYS platform the connection between a partner and the TYS platform environment may use HTTPS or TLS. The integration services may support OAuth v2. Alternatively, DID authorization may be supported for authentication between the TYS integration agent and a partner agent. Partners and TYS integration services will be issued certificates (keys) by the Fabric CA, which could carry cryptographic credentials. The certificates must specify attributes for roles, privileges, and certificate expiry. The exchange of information between the partner oracle and the integration APIs must be notarized as specified in the event header for the data exchange.

In an embodiment, the disclosure herein presents a system and method for digital identity management, a server managing one or more distributed ledgers. The server may be active to receive and aggregate business information and verification information associated with the business information from business organizations, where the business organizations may be Buyers, Sellers, or other business organizations. The server may commit the business information and associated verification information to one or more distributed ledgers, where the distributed ledgers may be one or more blockchains controlled and managed by the server. The server may provide controlled access to a first business organization to combined information supplied by a second business organization. In this embodiment the combined information may be composed of business information and verification information provided by the second business organization, one or more verification entities, and/or third-party information providers.

In an embodiment, the business information may consist of answers to questionnaires about business capabilities, and the verification information is composed of evidence verifying and attesting to the accuracy of said business information. In this embodiment, controlled access may be composed of providing such access through a commercial transaction between a first business organization and a second business organization where such commercial transaction is managed by the server. The server may return business information, verification information, and other third-party information retrieved from the one or more blockchains in a template format. Additionally, the controlled access is implemented by generating a set of one-time use encrypted keys and providing one-time use encrypted keys to the first business organization.

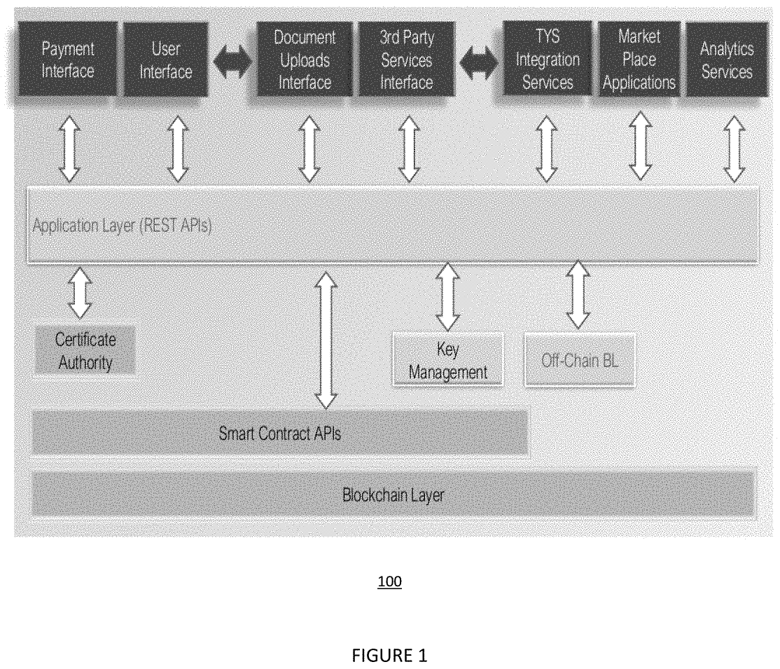

Turning now to FIG. 1, this figure presents a view of the end-to-end system interactive process components for the TYS platform consistent with certain embodiments of the present invention. The TYS platform is build on a layered architecture as depicted in the figure. The TYS platform is implemented on Hyperledger Fabric, a permissioned blockchain technology under the Linux Foundation's Hyperledger Project. Access to the blockchain and the smart contract functions are enabled by the Application Layer. The architecture supports third party development and deployment of market place apps that consume TYS APIs as well as the market place data.

In an embodiment, the blockchain layer provides the underlying capability to run Hyperledger Fabric software and protocols, deployed on the IBM Cloud Platform. Smart Contract APIs are the functions coded on the blockchain as a blockchain program, also known as chaincode, to execute business rules and perform CRUQ operations on the ledger. A certificate authority is a Fabric service that provides cryptographic credentials to Organizations, Users and other non-human participants. The platform provides a user interface to access the application functions and drive user workflow. The payment interface connects to payment services to accept subscriptions and other payments.

The TYS platform provides the functionality to upload documents. This function enables uploading, encrypting and secure storage of the uploaded documents in a document store on the platform. Integration services on the TYS platform provide middleware services to facilitate integration between the TYS system and outside parties, enterprise applications, and Market place applications to push or receive documents, data, and notifications. The TYS platform provides all functions required to perform supplier qualification and onboarding in an application layer. The application layer also interfaces to the blockchain using NodeJS Fabric SDK and interfaces to third party service providers.

The TYS platform provides an Off-chain blockchain as an NOSQL database that is used as application cache to securely store PII information and non-blockchain related data that does not require immutable records on the ledger. The TYS platform enable market place application to enable third parties and partner organizations to offer additional services on top of those services provided by the TYS platform by creating value added applications to which buyers and suppliers may subscribe. Non-TYS data may be stored by third parties on the platform for such purposes. Third party services are enabled to integrate with the TYS platform and augment the supplier presentations on the user interface with additional information in real-time, without loading such information into the TYS databases. The TYS platform also integrates with analytics and AI services, such as, in a non-limiting example, IBM Watson and Visko, to provide additional insights into the supplier qualification information.

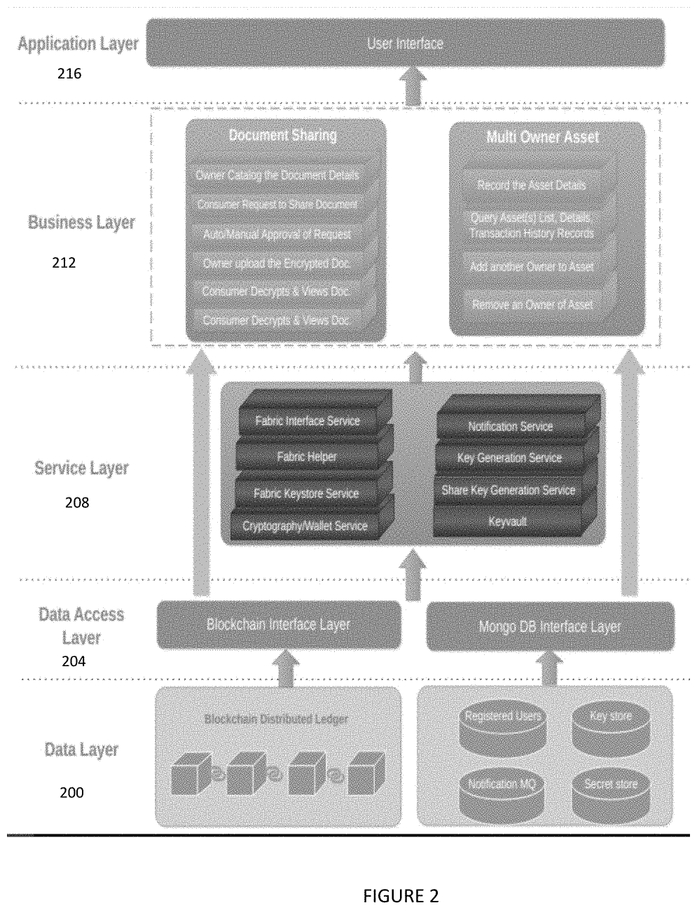

Turning now to FIG. 2, this figure presents a view of the end-to-end system integration architecture consistent with certain embodiments of the present invention. In an exemplary embodiment, the figure presents a typical integration scenario for the components of the Document Share platform.

At 200, the data layer, the blockchain distributed ledger, which may consist of a blockchain technology implemented on Hyperledger Fabric. The data layer also contains the various off-chain electronic storage elements. These storage elements provide storage areas for data about registered users and their account information, a notification message queue to store messages transmitted by the system, the Key store that contains the public keys and other information linking keys to users, and the secret store that contains the secrets associated with particular users that are used in authorization and authentication for document sharing.

At 204, the data access layer contains the APIs that will be active to interface with the blockchain and the off-chain data stores.

At 208, the service layer contains the applications and services that provide low level functions of the TYS platform. These applications and services contain, but are not limited to, a fabric interface service, fabric helper, and fabric keystore service, the cryptography and wallet service, the notification service for request notification, the key generation service to permit the generation and storage of keys for document access, the Share key generation service that creates the public share keys associated with users, and the Keyvault, which contains all of the assigned and active keys issued by the TYS platform to users.

At 212, the business layer contains the applications that enable and manage the document sharing and multi-owner management for various documents.

At 216, the application layer contains the user interface and access for outside partners and third-party developers to utilize the TYS platform for secure document sharing activities.

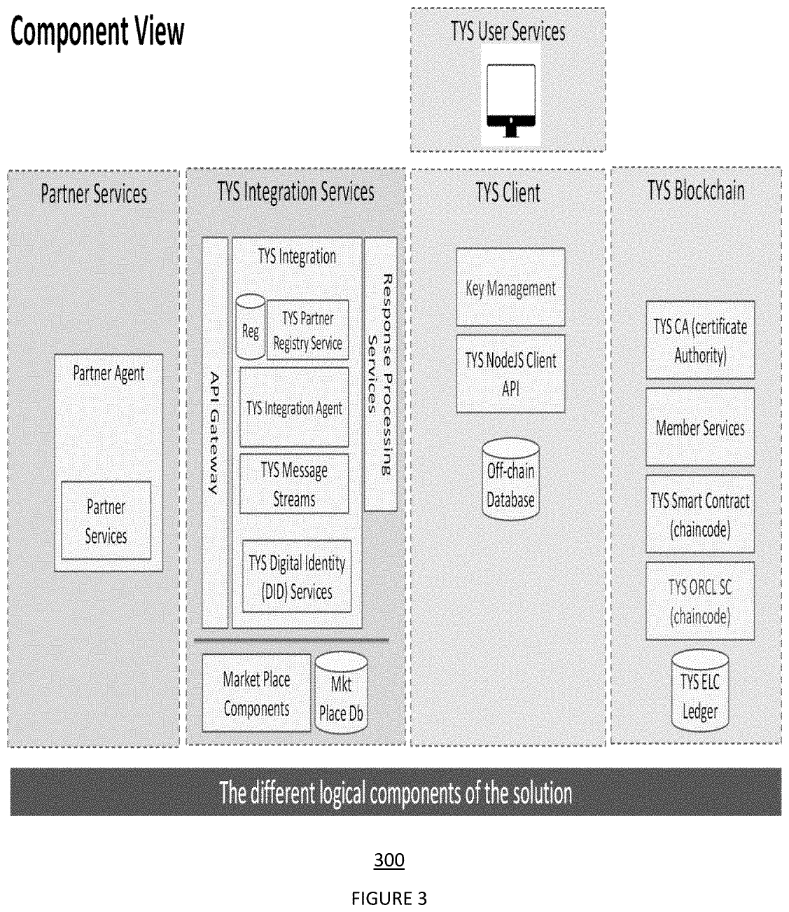

Turning now to FIG. 3, this figure presents a view of the application architecture overview and the logical components of the TYS platform consistent with certain embodiments of the present invention. In an exemplary embodiment, the figure presents the different logical components of the document sharing solution provided to users. These logical components include Partner services to permit outside partners to utilize the functions of the TYS platform. The TYS integration services that control and manage the processing of functions of the TYS platform that are accessible through the API gateway of the platform.

The TYS platform also controls user access through the TYS user services, which act through the TYS client established on the platform for each user. The client tracks and manages the generation and access to keys and connection and storage to and from the off-chain electronic storage databases. The TYS blockchain function tracks and manages the access to the TYS certificate authority, member services, the TYS smart contract application, also referred to as the chaincode manager, which also manages the blockchain database chaincode, and the manager of the blockchain distributed ledger and the distributed ledger itself.

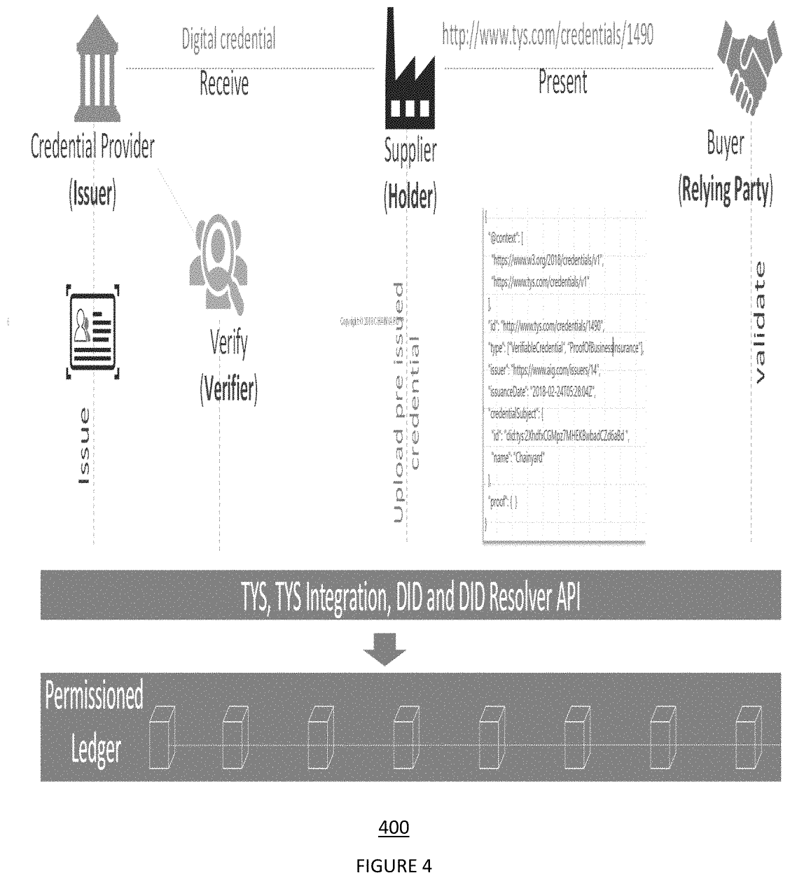

Turning now to FIG. 4, this figure presents a view of personal interaction with the blockchain and secure document sharing functions consistent with certain embodiments of the present invention. By way of example and not of limitation, at 400 this figure presents an implementation of the interaction between the system users and the permissioned distributed ledger. The services include issuing Digital Identifiers (DIDs) to new TYS business entities, registering verifiable credentials and providing a DID authentication service.

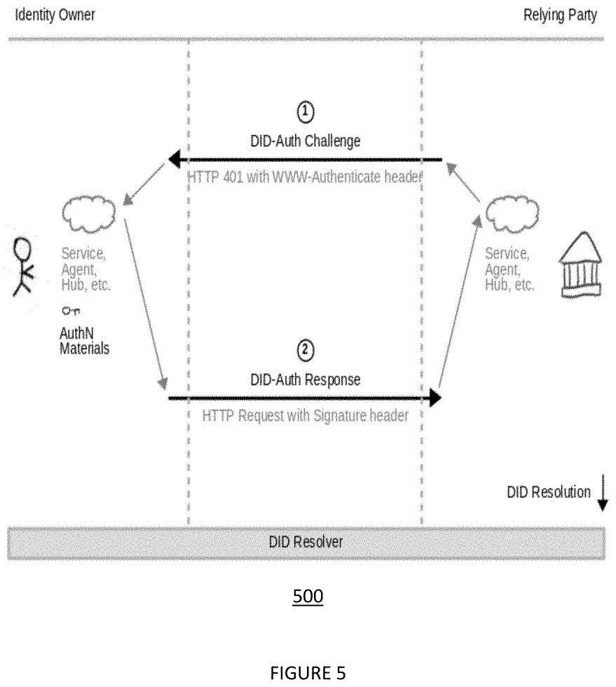

Turning now to FIG. 5, this figure presents a view of the Digital Identification (DID) authentication protocol consistent with certain embodiments of the present invention. In an exemplary embodiment, at 500 the DID authorization protocol enables the TYS Integration Agent to authenticate with the Partner Agent prior to the exchange of requests and responses. The DID authorization protocol the is implemented within the TYS platform follows the pattern shown in the figure.

In this embodiment, the relying party's service, agent, hub, or other application answers an HTTP request by returning HTTP code 401 with a WWW-Authenticate heater to an identity owner's service, agent, hub, or other application.

In response the identity owner's service, agent, hub, or other application sends an HTTP request to relying party's service, agent, hub, or other application and includes an HTTP signature.

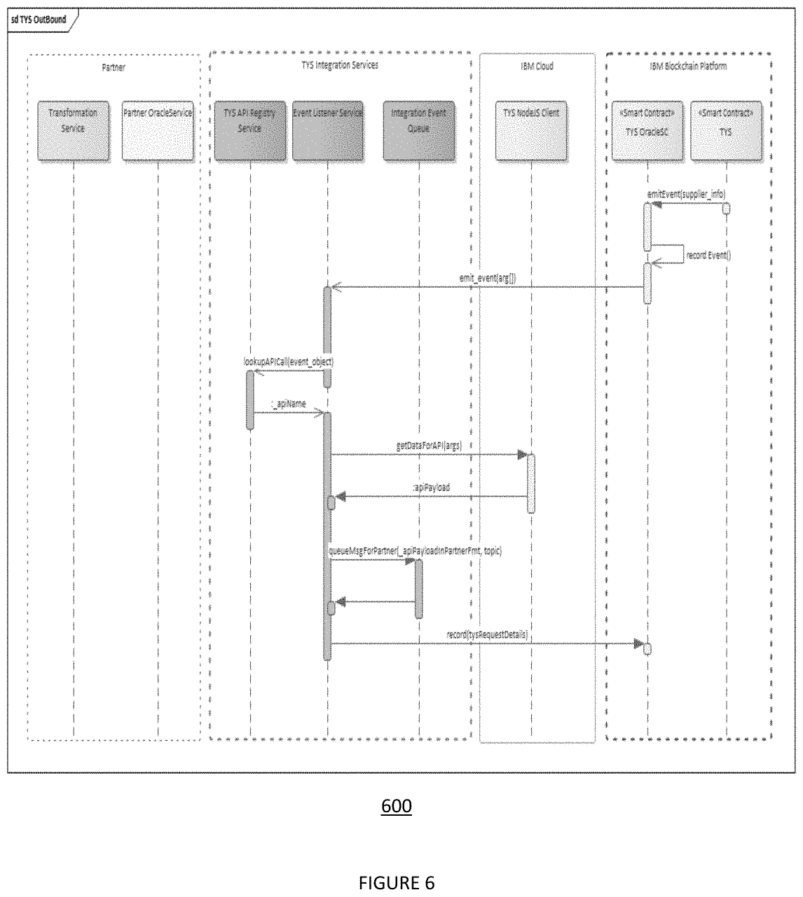

Turning now to FIG. 6, this figure presents a view of data and operation flow for the TYS platform outbound process consistent with certain embodiments of the present invention. In an embodiment, at 600 the process begins with a message from the TYS platform Smart Contract or Chaincode application to the TYS Oracle Smart Contract or Chaincode application. This message generates an event and emits the event to the TYS platform. The emitted event carries specific header information about the event such as an EventTypeID, EventID and payload information. The TYS event listener catches the event and parses the event headers. The event listener looks up the partner API that matches the event and transforms the payload using the transformation service. The event listener drops a message in the partner-specific topic on the integration event queue. The event listener service then unwraps the payload to determine the request to be processed. Upon completion of the request processing, the request details are transmitted to the TYS Oracle Smart Contract or Chaincode application for fulfillment of the smart contract.

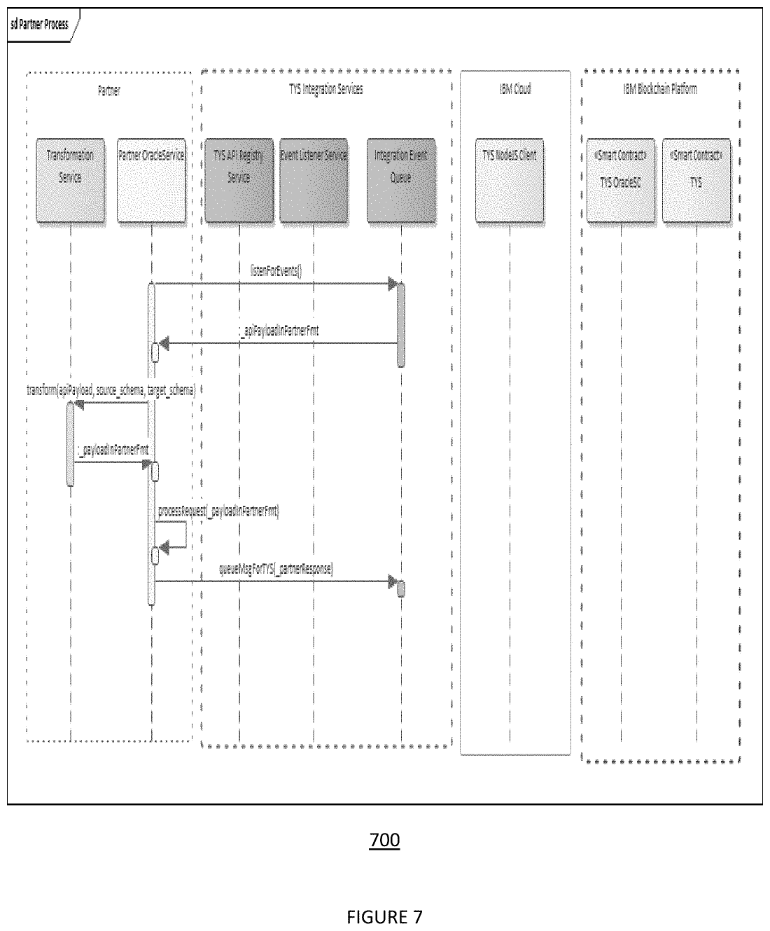

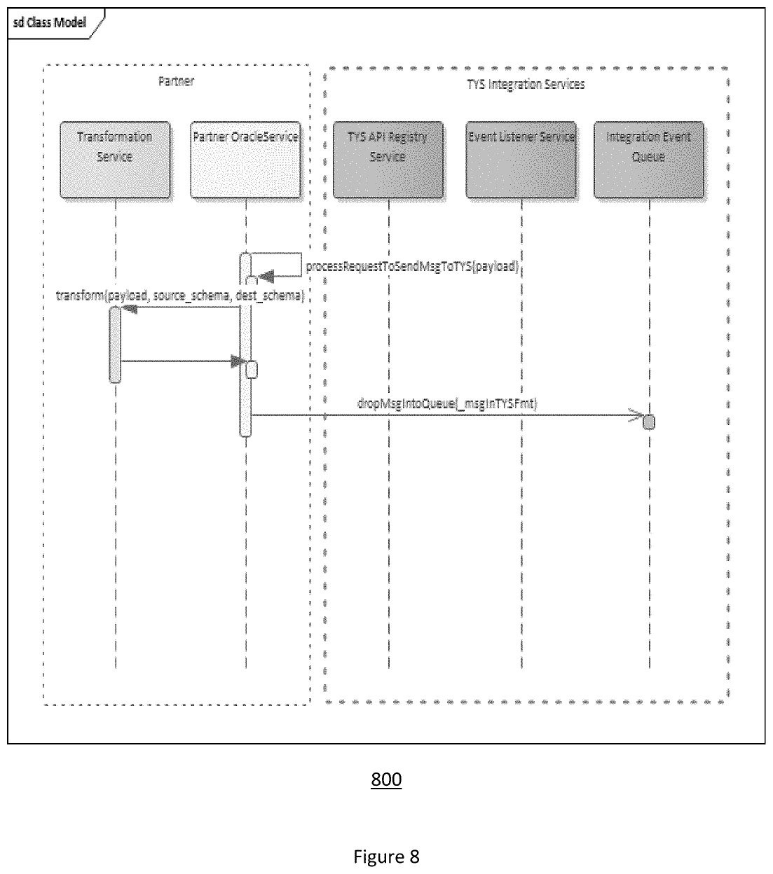

Turning now to FIG. 7, this figure presents a view of data and operation flow for the TYS platform partner process consistent with certain embodiments of the present invention. In an exemplary implementation, at 700, partner messaging between the TYS and partner service is asynchronous. The partner created Partner Oracle Service (POS) subscribes to topics on the TYS Integration Event Queue. The POS is responsible for picking up an event, transforming the payload to a consumable format and processing the now accessible partner request. Upon processing completion, the POS drops response on the integration event queue. Partner request processing is further described in FIG. 8.

Turning now to FIG. 8, this figure presents a view of data and operation flow for the TYS platform partner processing consistent with certain embodiments of the present invention. In an exemplary implementation, at 800, partners to the TYS platform and system may make requests to the TYS platform for information or data. If a partner wishes to request information, the partner will utilize the Oracle to transform and wrap the request into a TYS understandable message and drop it into the appropriate queue on the TYS Integration Event Queue. The Integration Event Queue will then process the message in the order in which it was received when the TYS event listener picks up and processes the message or event.

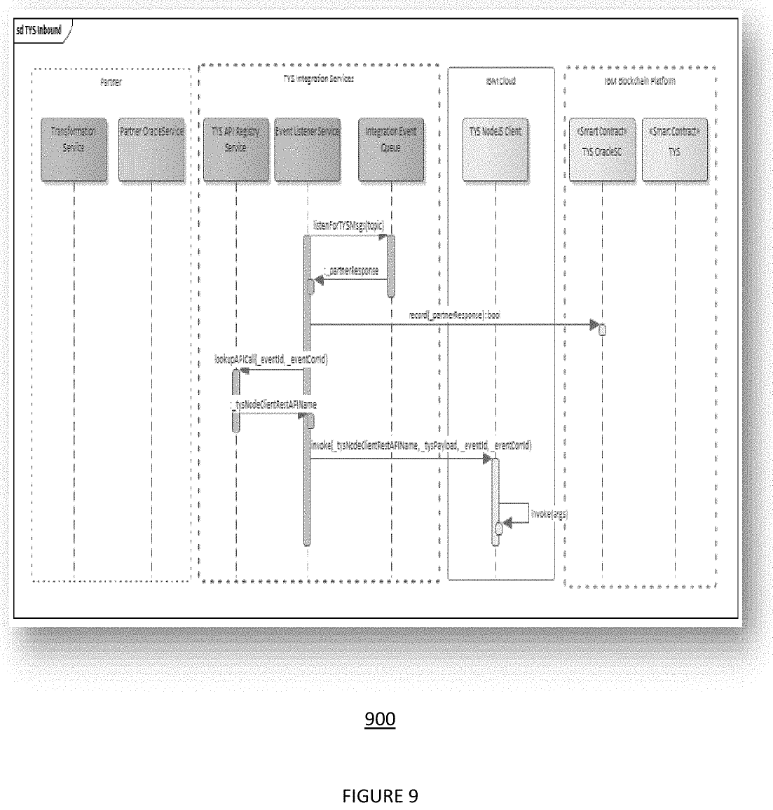

Turning now to FIG. 9, this figure presents a view of the inbound message processing for the TYS platform consistent with certain embodiments of the present invention. In an embodiment, at 900, the TYS event listener also subscribes to messages on the TYS partner event queue. The event listener processes queued messages in the same manner as outbound messages. In this embodiment, the event listener parses the event header and extracts the event type id and the event correlation id. The event listener then looks up the TYS API registry for the specific NodeJS API to be invoked. The NodeJS API transforms the inbound payload to a TYS consumable format. The event listener then invokes the appropriate REST API on the TYS NodeJS client.

The NodeJS client exposes APIs to process partner messages. A partner payload may contain additional data that TYS does not utilize or consume. The TYS platform will deposit unconsumed data in a separate collection that may be used by TYS market place applications to deliver additional services.

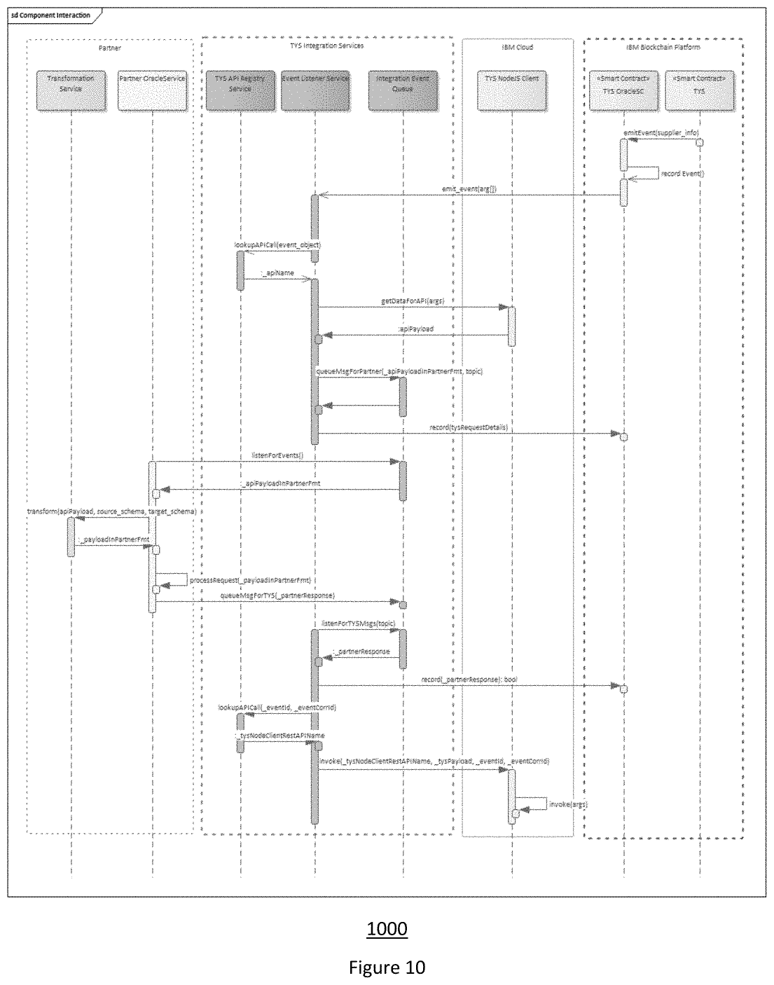

Turning now to FIG. 10, this figure presents a view of the complete TYS Application processing consistent with certain embodiments of the present invention. At 1000, this figure presents the integration of the TYS platform outbound message processing, partner processing, and inbound message processing to create a processing diagram for the complete component interaction within the TYS platform.

While certain illustrative embodiments have been described, it is evident that many alternatives, modifications, permutations and variations will become apparent to those skilled in the art in light of the foregoing description.

We claim:

1. A system for secure document sharing, comprising:
a server having a data processor acting to manage one or more distributed ledgers;
said server active to store one or more encrypted documents in an electronic storage that is not within a permissioned distributed ledger;
said server having a share client process, a key store, and a key generator;
said key generator generating one or more secure public/private key pairs and one or more secrets, assigning each key and each secret to a particular user or organization, and storing each of said keys in a key store and each secret in a secret store database;
said share client process active on said server to receive a request for a secure document from a requestor;
the share client active to enable sharing of a secure document through the use of a smart contract;
said share client process receiving an authorization and policy verification to complete the conditions of a smart contract associated with said request for a secure document;
the share client causing a secure document to be encrypted with an added impurity to the secure document to be shared;
said share client notifying a document owner of a request to share a secure document;
said document owner providing a secret assigned to said second client for comparison with a secret stored within said secret store database;
said share client determining that said smart contract conditions have been met and decrypting and storing said secure document in an anonymous store database.
said processor providing access to said anonymous store database for requestor to retrieve the decrypted secure document.

2. A system according to claim 1, where said one or more distributed ledgers comprises one or more provisioned blockchains.

3. A system according to claim 2, where each of said secure documents are encrypted and stored external to any permissioned distributed ledger.

4. A system according to claim 1, where said smart contract is enabled to issue shared secrets to each requestor and document owner where said shared secrets are created using the Shamir secret generation algorithm.

5. A system according to claim 4, where each share for said shared secrets is driven by a smart policy that is stored on the permissioned distributed ledger and issued by the document owner.

6. A system according to claim 5, where each share and its access is stored on the permissioned distributed ledger.

7. A system according to claim 1, where said added impurity is a water-mark that is added to each document prior to encryption of the document to create a secure document.

8. A system according to claim 1, where each secure document is shared by the document owner with any requester through a request-response approach controlled by one or more smart policies.

9. A system according to claim 1, where share events and a file access policy for each document share transaction are added as records to one or more permissioned distributed ledgers.

10. A system according to claim 1, where a wallet is created for each requestor and document owner within an electronic storage database maintained on said server, and where each generated secret share and each private key for all requestors and document owners are stored within the generated wallet.
